(19) United States
(12) Patent Application Publication
(10) Pub. No.: US 2025/0303403 A1
(43) Pub. Date: Oct. 2, 2025

(54) BEAD CONSUMABLES AND LAB TECHNIQUES FOR SAMPLE PREPARATION

(71) Applicant: DH Technologies Development Pte. Ltd., Singapore (SG)

(72) Inventors: Amit PATEL, Shrewsbury, MA (US); Aaron STELLA, Derry, NH (US)

(73) Assignee: DH Technologies Development Pte. Ltd., Singapore (SG)

(21) Appl. No.: 18/864,043

(22) PCT Filed: May 10, 2023
(86) PCT No.: PCT/IB2023/054837

§ 371 Date: Nov. 8, 2024

Related U.S. Application Data
(60) Provisional application No. 63/340,089, filed on May 10, 2022.

(51) Int. Cl. B01L 3/00

(52) U.S. Cl. CPC B01L 3/502; B01L 2200/0689; B01L 2200/16; B01L 2300/042; B01L 2300/047; B01L 2300/0681; B01L 2300/0832; B01L 2400/043; B01L 2400/0683

(57) ABSTRACT

A method for processing a sample in a container includes introducing the sample to the container. A cap is applied to the container. The cap contains a plurality of beads. The plurality of beads is mixed with the sample. The plurality of beads is separated from the sample. Subsequent to removing the plurality of beads, a further process is initiated.

### CROSS-REFERENCE TO RELATED APPLICATION

This application is being filed on May 10, 2023, as a PCT International Patent Application that claims priority to and the benefit of U.S. Provisional Application No. 63/340,089, filed on May 10, 2022, the disclosure of which is hereby incorporated by reference in its entirety.

### INTRODUCTION

For sample preparation workflows which require multiple sample processing steps (e.g., multiple liquid transfers, multiple bead transfers, solid phase extraction, liquid-liquid extraction), standard lab practices require the use of multiple sample containers (e.g., tubes, vials) and pipette tips, thus, adding risk of contamination or sample losses (e.g., non-quantitative transfer or adsorption to surfaces), increasing the costs of consumables, and increasing labor costs.

The use of magnetic beads in sample preparation, such as those which have been chemically modified to capture or concentrate analytes or to remove matrix or contaminants or background peaks, typically necessitates the removal or segmentation of the magnetic beads prior to sample analysis. Furthermore, the use of such modified magnetic beads has been shown to significantly reduce the number of sample preparation steps and their use is generally automation compatible.

### SUMMARY

In one aspect, the technology relates to a method for processing a sample in a container, the method including: introducing the sample to the container; applying a cap to the container, wherein the cap contains a plurality of beads; mixing the plurality of beads with the sample; separating the plurality of beads from the sample; and subsequent to removing the plurality of beads, initiating a further process. In an example, the method further includes introducing a reagent to the container prior to introducing the sample to the container. In another example, the method further includes introducing the sample to the cap, prior to mixing the plurality of beads with the sample. In yet another example, separating the plurality of beads from the sample includes rupturing the cap, thereby initiating the introduction of the sample to the container, and wherein the cap retains the plurality of beads within the cap during rupturing of the cap. In still another example, mixing the plurality of beads with the sample includes inverting the container so as to contact the plurality of beads in the cap with the sample; separating the plurality of beads from the sample includes uprighting the container; and the method further includes introducing a reagent to the container, prior to initiating a further process of the sample.

In another example of the above aspect, the plurality of beads are non-magnetic. In an example, the method further includes subsequent to introducing the sample to the cap, rupturing the cap, thereby initiating the introduction of the sample to the container and introducing the plurality of beads to the container, and wherein separating the plurality of beads from the sample includes, subsequent to introducing the plurality of beads to the container, applying a magnetic force to the plurality of beads and separating the beads from the sample. In another example, applying the magnetic force to the plurality of beads draws the plurality of beads into the cap, and wherein the method further includes removing the cap from the container along with the plurality of beads. In yet another example, the method further includes subsequent to introducing the sample to the cap, applying a magnetic force to the plurality of beads so as to retain the plurality of beads in the cap; and rupturing the cap, thereby initiating the introduction of the sample to the container. In still another example, applying the magnetic force and rupturing the cap are performed substantially simultaneously.

In another example of the above aspect, the method further includes rupturing the cap, thereby initiating the mixing of the plurality of beads with the sample, and wherein removing the plurality of beads from the sample includes applying the magnetic force to the plurality of beads to draw the plurality of beads into the cap. In an example, introducing the sample to the container includes introducing the sample to an upper compartment of the container. In another example, the method further includes subsequent to introducing the plurality of beads to the sample, rupturing a barrier between the upper compartment of the container and a lower compartment. In yet another example, the method further includes prior to rupturing the barrier, applying a magnetic force to the plurality of beads so as to at least one of retain the plurality of beads in the upper compartment of the container and draw the plurality of beads into the cap.

In another aspect, the technology relates to a cap for a sample container, the cap includes: a housing defining an inner chamber; a base connected to the housing; a sealing rim connected to the housing and substantially surrounding the base for sealing engagement with the sample container; and a plurality of beads disposed in the inner chamber. In an example, the cap further includes a rupturable lid. In another example, the base is rupturable. In yet another example, the cap further includes a filter wall disposed in the inner chamber, wherein the filter wall separates the inner chamber into a sample chamber and a bead chamber, wherein the plurality of beads are contained in the bead chamber, and wherein the rupturable base at least partially defines the sample chamber. In still another example, the base includes a filter.

In another aspect, the technology relates to the container for processing a sample, the container includes: an upper chamber; a lower chamber; a rupturable wall separating the upper chamber and the lower chamber; and a cap sealingly connected to the upper chamber, wherein the cap includes an inner chamber and a plurality of beads disposed in the inner chamber.

### BRIEF DESCRIPTION OF THE DRAWINGS

FIGS. 1A and 1B depicts a cross-sectional view and a bottom view, respectively, of an example cap, including a plurality of beads.

FIGS. 2A and 2B depicts a cross-sectional view and a bottom view, respectively, of another example cap, including a plurality of beads.

FIG. 3 depicts a cross-sectional view of another example cap, including a plurality of beads.

FIG. 4 depicts a cross-sectional view of a multi-compartment container with an example cap, including a plurality of beads.

FIG. 5 depicts a cross-sectional view of a multi-compartment container, including a plurality of beads, with an example cap.

FIG. 6 depicts a method of processing a sample in a container, in accordance with various examples.

FIGS. 7A-7C depict an example method of processing a sample in a container, in accordance with the method of FIG. 6.

FIGS. 8A-8E depict another example method of processing a sample in a container, in accordance with the method of FIG. 6.

FIGS. 9A-9C depict another example method of processing a sample in a container, in accordance with the method of FIG. 6.

FIGS. 10A-10C depict another example method of processing a sample in a container, in accordance with the method of FIG. 6.

FIGS. 11A-11E depict another example method of processing a sample in a container, in accordance with the method of FIG. 6.

### DETAILED DESCRIPTION

The technologies described herein address the above-described challenges through the physical separation of beads from a sample. Various configurations of caps, containers, and beads are described herein. Methods of use of such described components are varied, due in part to the versatility of the components. Orders of operations of such methods would be apparent to a person of skill in the art, but generally include introducing one or more liquids at various stages between compartments of the caps and containers. Beads are also sometimes utilized to mix the sample, introduce analytes of other compounds to the sample, remove target analytes therefrom, etc. The liquids may be samples, reagents, wash liquids, or other liquids, each of which may include one or more binding agents, molecules, analytes, etc.

As used herein, the term “binding agent” refers to a molecule capable of specifically binding a target analyte. A binding partner can be any of a number of different types of molecules, including an antibody or antigen-binding fragment thereof, or other protein, peptide, polysaccharide, lipid, a nucleic acid or nucleic-acid analog, such as an oligonucleotide, aptamer, or PNA (peptide nucleic acids). The term “target analyte” refers to a molecule, compound, or other component in a sample. Target analytes may include but are not limited to peptides, proteins, polynucleotides, organic molecules, sugars and other carbohydrates, and lipids. The term “specific binding” refers to binding of an antibody or other binding agent to an epitope on a cell or target analyte to which the antibody or binding agent is targeted.

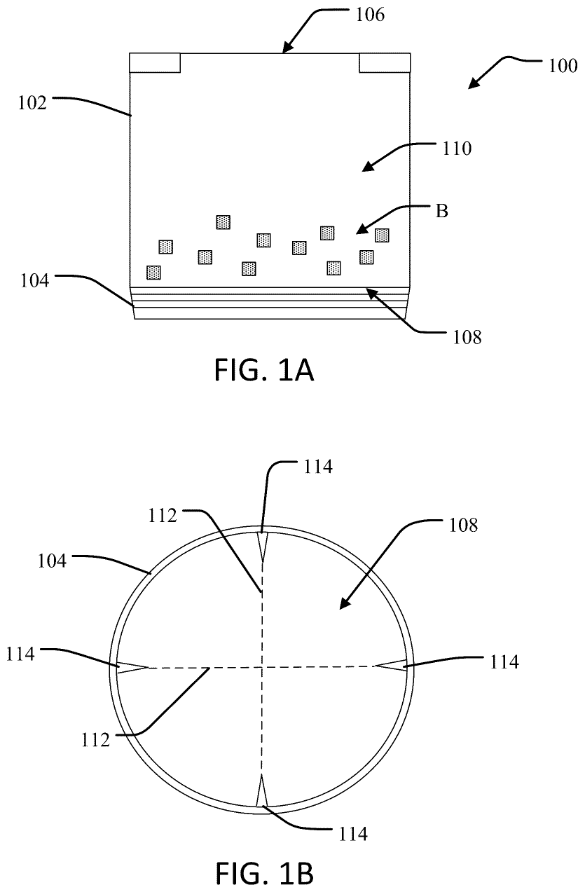

FIGS. 1A and 1B depicts a cross-sectional view and a bottom view, respectively, of an example cap 100, including a plurality of beads B, which may be either magnetic or non-magnetic, as required or desired for a particular application. Both FIGS. 1A and 1B are described concurrently and not every feature described is depicted in both figures. The cap 100 may be formed of a unitary piece of injection molded plastic and may include an outer housing 102. The housing 102 may be substantially cylindrical and may include a press-fit sealing rim 104 for sealingly securing the cap 100 to a container such as a vial, tube, well, or other container. A lid 106 may form an upper extent of the cap 100, while a rupturable base 108 may be disposed adjacent the sealing rim 104, which may substantially surround the base 108. Together, the substantially cylindrical housing 102, the lid 106, and the base 108 form an inner chamber 110 in which the beads B are disposed. The lid 106 may be penetrable (e.g., by a pipette or needle via a silicone or polytetrafluoroethylene (PTFE) septum), or removable (e.g., by lifting or unscrewing from the housing 102), or otherwise configured to enable access to the inner chamber 110. A liquid sample may be introduced to the inner chamber 110 (as well as the beads B disposed therein) as described in more detail herein. In the depicted cap 100, the rupturable base 108 defines a plurality of faults 112, or weak points in the material thereof. Adjacent the faults 112 are one or more breaching features 114 for rupturing the base 108 along the faults 112. In this configuration, as the rim 104 is pressed into a mouth of a vial or other container, the force radially compresses the rim 104, which forces the breaching features 114 inward, thereby damaging and rupturing the faults 111 of the rupturable base 108. Once ruptured, the materials within the inner chamber 110 (e.g., the sample and, in some cases, the plurality of beads B), fall into the vial which may contain another liquid, where further reactions may take place, as described herein.

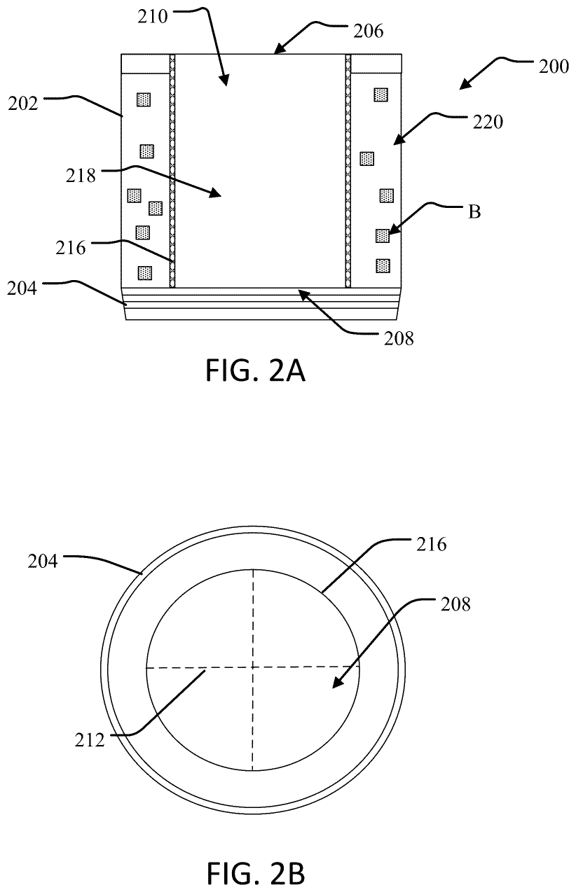

FIGS. 2A and 2B depicts a cross-sectional view and a bottom view, respectively, of another example cap 200, including a plurality of beads B, that in this example, are non-magnetic. In an alternative configuration, the beads B may be magnetic, but such a feature is not required, given the configuration of the cap 200. As described above in the context of FIGS. 1A and 1B, the cap 200 may include a housing 202, a sealing rim 204, a lid 206, and a base 208 that form an inner chamber 210. One or more faults 212 may be present in the material of the base 208 to aid in the rupturing or penetration thereof. The inner chamber 210 is further divided by a filter wall 216 into a sample chamber 218 and a bead chamber 220 in which the beads B are retained. The faults 212 may only extend as far as the filter wall 216. The filter wall 216 may be a filter, mesh, screen, or other perforated structure sized to allow flow of liquid therethrough, but to also retain the beads B therein during processes described herein. In this configuration of cap 220, a sample may be introduced through the lid 206, for example, by the various methods described above with regard to FIGS. 1A and 1B. Once the sample is disposed in the inner chamber 210, the inner chamber 210 may be re-sealed (e.g., by replacement of the lid 206 or by a closing of a septum in the lid 206) and the cap vortexed or otherwise agitated to enhance mixing between the sample and the beads. Thereafter, the rupturable base 208 may be compromised (e.g., by pushing a pipette or tool through the sample chamber 218 and to rupture the base 208), thereby causing the sample to fall into a connected vial, while the filter wall 216 retains the beads in the cap 200.

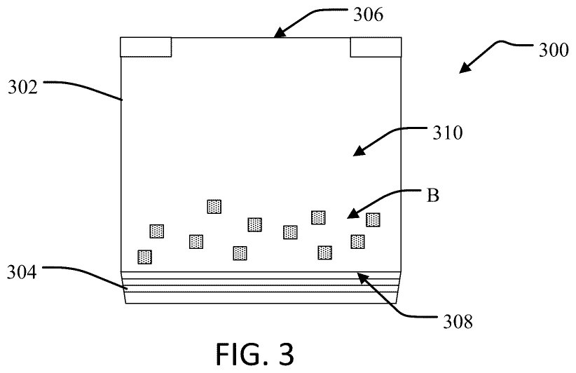

FIG. 3 depicts a cross-sectional view of another example cap 300, including a plurality of beads B, that in this example, are non-magnetic. In an alternative configuration, the beads B may be magnetic, but such a feature is not required, given the configuration of the cap 300. As described above in the context of FIGS. 1A and 1B, the cap 300 may include a housing 302, a sealing rim 304, a lid 306, and a base 308 that form an inner chamber 310 containing the beads B. The base 308 in this configuration is not rupturable, rather, it is formed of a filter, mesh, screen, or other perforated material that enables liquid flow into the inner chamber 310, while retaining the beads B therein. For example, the cap 300 may be sealed to a vial or other container 300 containing a sample. Thereafter, the vial/cap may be inverted, thereby allowing the sample to flow into the inner chamber 310, where mixing with the beads B may be performed (e.g., by agitating, vortexing, or other methods). Once sufficiently mixed, the vial/cap combination may be uprighted (removed from inversion), allowing the sample to return to the vial, while the beads B remain separate therefrom in the inner chamber 310. In another example, the cap 300 may be secured to a vial, and a sample introduced via the lid 306 (e.g., as described above), allowing the sample to wash over the beads B, prior to falling through the base 308 and into the vial below.

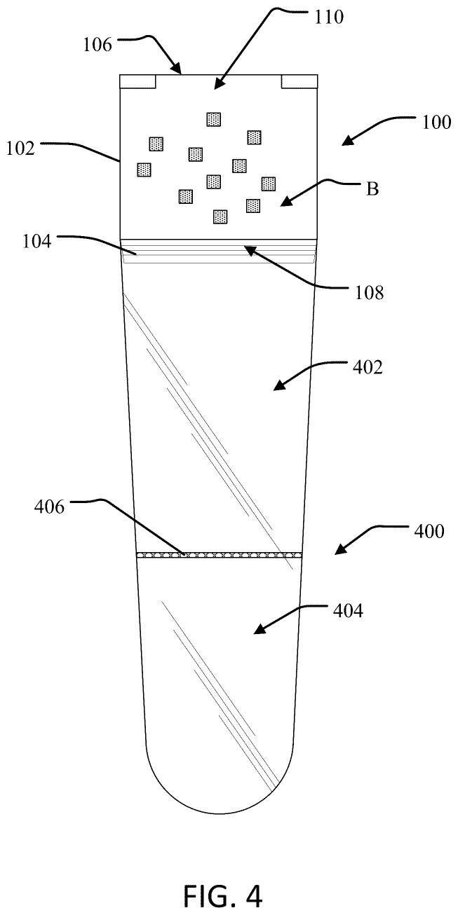

FIG. 4 depicts a cross-sectional view of a multi-compartment container 400 with an example cap 100, including a plurality of beads B. The cap 100 depicted corresponds to that depicted in FIGS. 1A and 1B for illustrative purposes, but other caps described herein may also be utilized. Further, certain of the features of the cap 100 are not necessarily described further in the context of FIG. 4. In this example, the multi-compartment container 400 includes an upper compartment 402 and a lower compartment 404. The upper compartment 402 and lower compartment 404 may be separated by a wall 406 which may be rupturable, similar to the rupturable base described in the context of certain cap configurations herein. In other examples, the wall 406 is not rupturable, but rather penetrable, e.g., by a needle. In other examples, the wall 406 may be a robust screen or mesh similar to the filter wall described above in the context of the cap 200 of FIGS. 2A and 2B above. The multi-compartment container 400 enables multiple reactions to be performed therein, with or without the specialized caps described herein. In one use example, a liquid sample may be introduced to the inner chamber 110 of the cap 100, where it is mixed with the beads B. The base 108 may then be ruptured, causing the beads B and sample to fall into the upper compartment 402, which may contain, e.g., a second liquid to cause a different reaction. Thereafter, the wall 406 may be ruptured, enabling the sample to fall into the lower compartment 404. The beads B may be retained in the upper compartment 402 (if magnetic) as described herein, or allowed to fall into the lower compartment 404. In another example, the portion of the housing defining the upper compartment 402 may be disconnected from the portion of the housing defining the lower compartment 404.

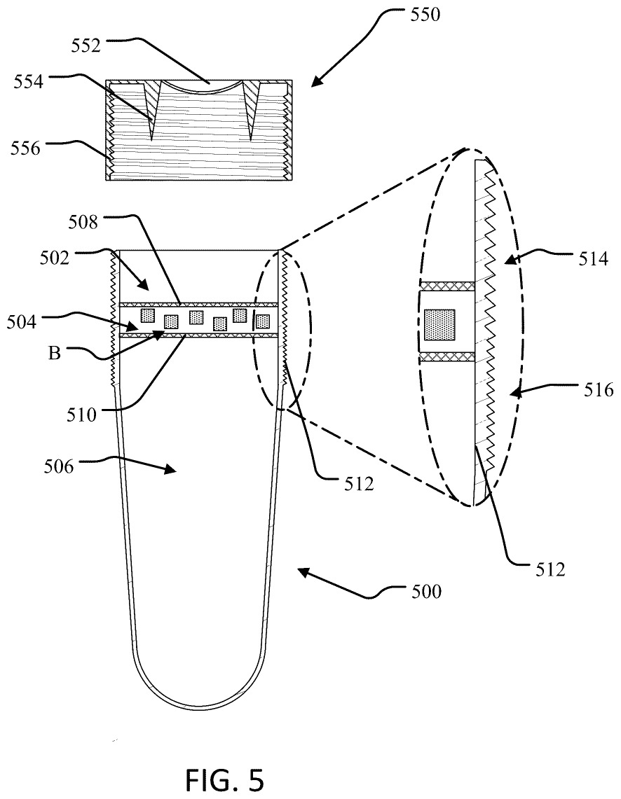

FIG. 5 depicts a cross-sectional view of a multi-compartment container 500, including a plurality of beads B, with an example cap 550. The container 500 includes an upper chamber 502, a bead chamber 504 containing a plurality of beads B, and a lower chamber 506. The upper chamber 502 is separated from the bead chamber 504 by a wall 508 which may be rupturable (in examples, the wall 508 may also be permeable, such as the mesh or screen described in other examples). The lower chamber 506 is separated from the bead chamber 504 by a wall 510 which may be rupturable (in examples, the wall 510 may also be permeable, such as the mesh or screen described in other examples). The container 500 may include a threaded connection 512, which may include a plurality of different thread forms 514, 516, two of which are depicted in FIG. 5, though more thread forms are contemplated. The thread forms 514, 516 may be different as to roughness, shape, thickness, breakable segment, etc., so as to provide multiple depth settings for the cap 550.

With the three chambers 502, 504, 506, multiple sequential processes may be performed as required or desired. Those processes may be at least partially driven by utilization of the cap 550. The cap 550 includes an upper septum 552 that may be pierceable (e.g., by an injection needle) or rupturable, though a pierceable septum 552 may provide enhanced utility. One or more barrier breaking elements 554 may be configured to rupture the walls 508, 510 as the cap 550 is advanced onto the container 500. Threads 556 may engage the threads 512 on the vial 500. In examples, application of the cap 550 to the container 500 may be to different depths, such that processes may be performed sequentially. For example, the cap 550 may be advanced to a first position where sealing of the cap 550 to the container 500 may be attained. The cap 550 may be advanced to a second position where the barrier breaking elements 554 may penetrate the wall 508. This rupturing may be accompanied by a change in rotational resistance of the cap 550 (e.g., due to a change in the thread forms). Additionally or alternatively, the rupturing may be accompanied by a sound emitted by the wall 508 as the rupturing occurs. The cap 550 may be further advanced to a third position where the barrier breaking elements 554 may penetrate the wall 510. This rupturing may be accompanied by a change in rotational resistance of the cap 550 (e.g., due to a change in the thread forms). Additionally or alternatively, the rupturing may be accompanied by a sound emitted by the wall 510 as the rupturing occurs. At each position, one or more samples, reagents, or other liquids may be introduced to the container (e.g., via the septum 552), the container 500 may be agitated or inverted to mix the liquids therein (e.g., with the beads B), heat may be applied, the beads B may be magnetically agitated (if magnetic), or other processes may be performed. In examples, the contents of the container 500 may be removed (e.g., with a pipette), while the beads B (if magnetic) are retained via application of a magnetic force, such as described herein.

Materials used for the containers and caps may be consistent with those known in the art. For example, containers may be shaped as tubes, vials, or as discrete wells within a body such as a microplate. Materials used may be plastic, glass, amber glass, etc. The cap may be manufactured of similar materials, though robust plastics are likely more versatile, in that plastic may be manufactured so as to break without separating into shards. Such material properties are less likely with glass, although engineered glasses less prone to shattering may, however, be utilized.

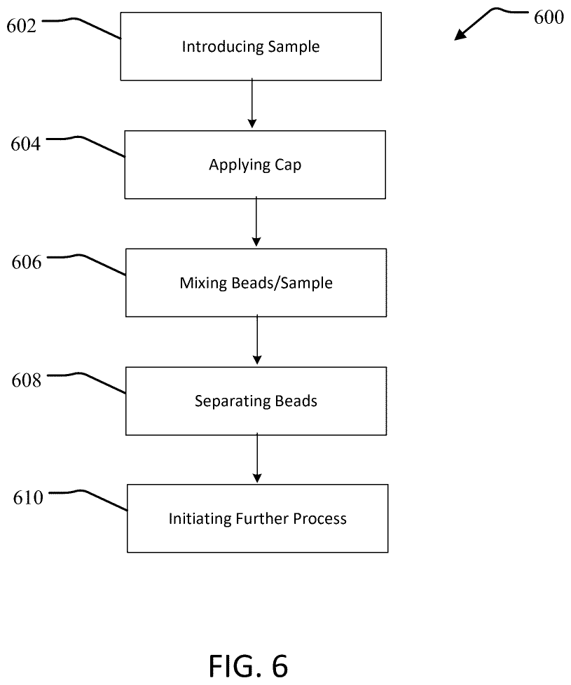

FIG. 6 depicts a method 600 of processing a sample in a container, in accordance with various examples. The operations of the depicted method 600 may be performed in a variety of orders, often dictated by the type of cap used (e.g., such as the caps depicted herein), the type of containers used (e.g., single or multi-chamber containers, as described herein), number of types of reagents introduced, order of reagent introduction or sample introduction, types of beads used, analytes disposed on the beads, processing equipment available, etc. The basic method 600 itself is described in the context of FIG. 6. Following FIG. 6 are a number of examples of implementations of the method 600, utilizing, for example, certain of the caps and containers depicted and described herein. Further implementations would be apparent to a person of skill in the art upon reading this disclosure. In examples, the container contains a reagent prior to the method 600 being performed. The method 600 begins with an Introducing Sample operation 602, which may include introducing a sample to the container or cap. The method 600 includes an Applying Cap operation 604, which may include applying a cap to the container. The cap may be preloaded with a plurality of beads, such as the magnetic or non-magnetic beads. In an example, the plurality of beads may include a receptor to bind a target analyte in the sample. The method 600 also includes a Mixing Beads/Sample operation 606, where the plurality of beads are mixed with the sample. The method 600 also includes a Separating Beads operation 608, where the plurality of beads are separated from the sample. The method 600 also includes an Initiating Further Process operation 610, which may include further washing operations, introduction of additional reagents, or other processes as known in the art.

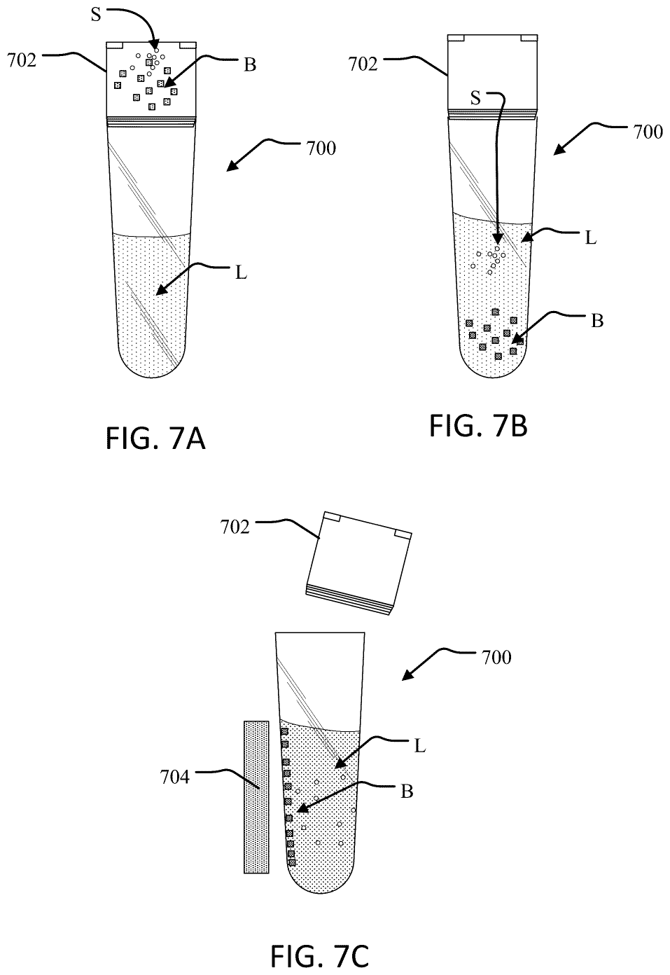

With this basic method 600 in mind, a number of examples of implementing the method 600 with further teachings are described herein. FIGS. 7A-7C depict an example method of processing a sample S in a container 700, in accordance with the method of FIG. 6. A cap 702 containing a plurality of magnetic beads B is also depicted and the container 700 may also contain a liquid L, which may be a reagent, wash, or other liquid. The cap 702 may be consistent with the cap 100 depicted in FIGS. 1A and 1B. This implementation of the method 600 begins with the Applying Cap operation, where the cap 702 containing the beads B is secured to the container 700. A cap 702 containing beads decorated with one or more substances displaying a particular affinity with a target within the sample S may be first selected, as required or desired for a particular process. In FIG. 7A, the Introducing Sample operation is performed by introducing the sample S via the cap 702, e.g., by injecting the sample S into the cap with a needle through a septum, as described herein. The Mixing Beads/Sample operation may be performed by agitating or vortexing the container 700 and cap 702. Thereafter, the cap 702 may be ruptured, causing the beads B and the sample S to fall into the container 700 of liquid L, as depicted in FIG. 7B. There, further agitating or vortexing may be performed to mix the beads B in the liquid L. In FIG. 7C, the Separating Beads operation is performed by placing a magnet 704 adjacent the container 700 to draw the beads B thereto. The liquid remaining in the container 700 may be removed e.g., via a pipette, once the cap 702 is removed. Thereafter, the Initiating Further Process operation may performed, as known in the art.

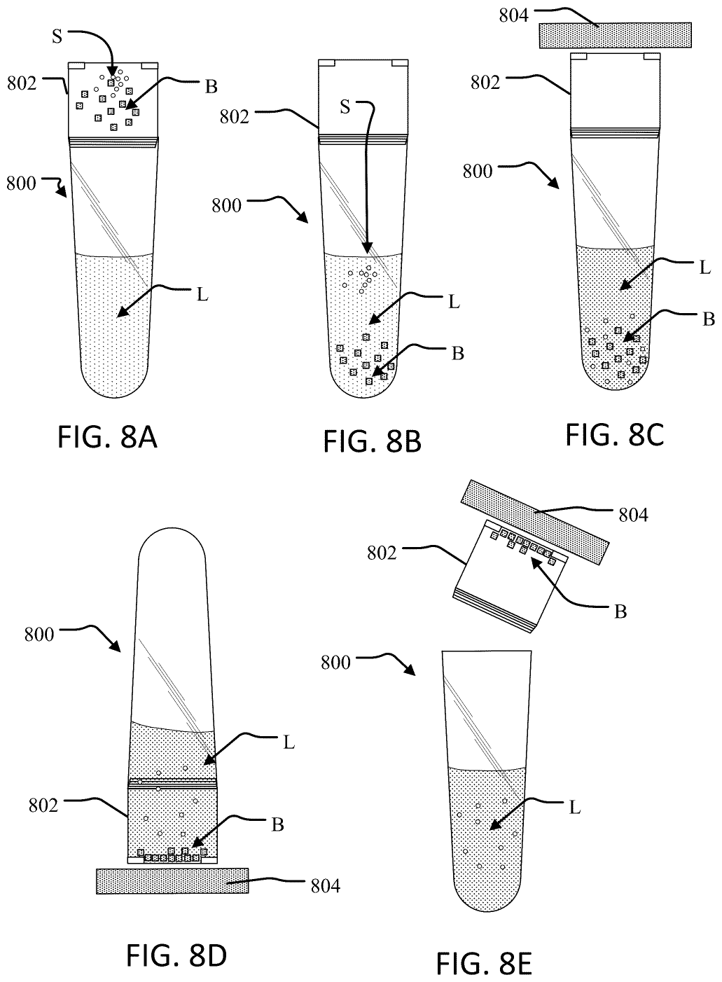

FIGS. 8A-8E depict another example method of processing a sample in a container, in accordance with the method of FIG. 6. A cap 802 containing a plurality of magnetic beads B is also depicted and the container 800 may also contain a liquid L, which may be a reagent, wash, or other liquid. The cap 802 may be consistent with the cap 100 depicted in FIGS. 1A and 1B. This implementation of the method 600 begins with the Applying Cap operation, where the cap 802 containing the beads B is secured to the container 800. A cap 802 containing beads B decorated with one or more substances displaying a particular affinity with a target within the sample S may be first selected, as required or desired for a particular process. In FIG. 8A, the Introducing Sample operation is performed by introducing the sample S via the cap 802, e.g., by injecting the sample S into the cap 802 with a needle through a septum, as described herein. The Mixing Beads/Sample operation may be performed by agitating or vortexing the container 800 and cap 802. Thereafter, the cap 802 may be ruptured, causing the beads B and the sample S to fall into the container 800 of liquid L, as depicted in FIG. 8B. There, further agitating or vortexing may be performed to mix the beads B in the liquid L. In FIG. 8C, the Separating Beads operation begins by placing a magnet 804 adjacent the cap 802. The container 800 and cap 802 is then inverted as depicted in FIG. 8D, such that the beads B fall into the cap 802 (where they are retained by the magnet 804). The container 800 is then uprighted and the cap 802 removed, as depicted in FIG. 8E. With the magnet 804 adjacent the cap 802, the beads B are retained therein to complete the Separating Beads operation. The liquid remaining in the container 800 may be removed e.g., via a pipette, once the cap 802 is removed. Thereafter, the Initiating Further Process operation may performed, as known in the art.

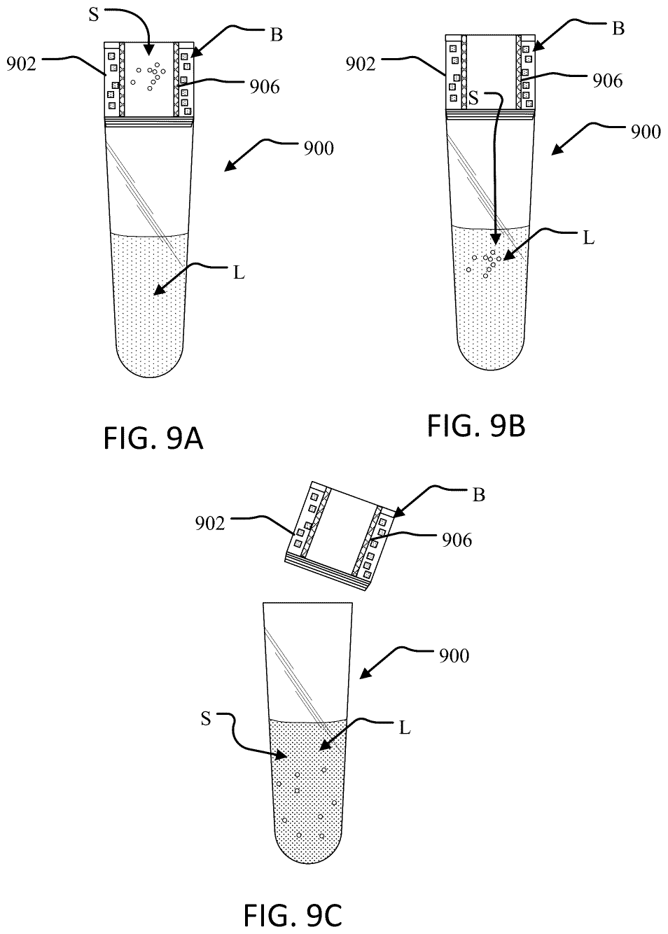

FIGS. 9A-9C depict another example method of processing a sample S in a container 900, in accordance with the method of FIG. 6. A cap 902 containing a plurality of beads B is also depicted and the container 900 may also contain a liquid L, which may be a reagent, wash, or other liquid. The cap 902 may be consistent with the cap 200 depicted in FIGS. 2A and 2B. This implementation of the method 600 begins with the Applying Cap operation, where the cap 902 containing the beads B is secured to the container 900. A cap 902 containing beads B decorated with one or more substances displaying a particular affinity with a target within the sample S may be first selected, as required or desired for a particular process. In FIG. 9A, the Introducing Sample operation is performed by introducing the sample S via the cap 902, e.g., by injecting the sample S into the cap 902 with a needle through a septum, as described herein. The Mixing Beads/Sample operation may be performed by agitating or vortexing the container 900 and cap 902, such that the sample S mixes with the beads B retained behind a filter wall 906, as described herein. Thereafter, the cap 902 may be ruptured, causing the sample S to fall into the container 900 of liquid L, as depicted in FIG. 9B. In doing so, the Separating Beads operation is performed by the beads B being retained in the cap 902. The liquid remaining in the container 900 may be removed e.g., via a pipette, once the cap 902 is removed. Thereafter, the Initiating Further Process operation may performed, as known in the art.

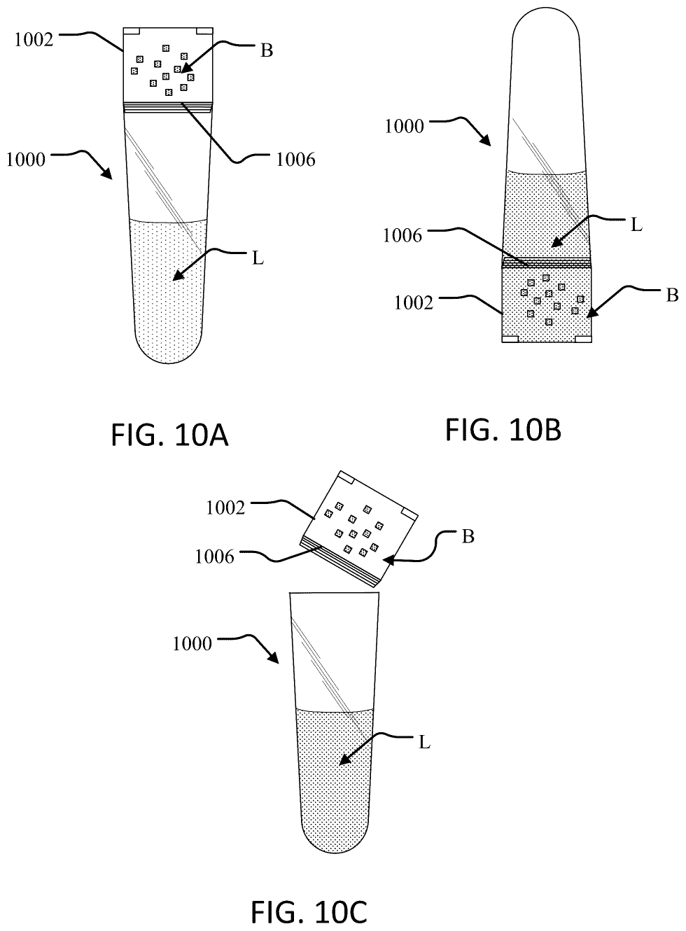

FIGS. 10A-10C depict another example method of processing a sample in a container 1000, in accordance with the method of FIG. 6. A cap 1002 containing a plurality of beads B is also depicted and the container 1000 may also contain a liquid L, which may be a sample, or other liquid. The cap 1002 may be consistent with the cap 300 depicted in FIG. 3. This implementation of the method 600 begins with the Applying Cap operation, where the cap 1002 containing the beads B is secured to the container 1000, as depicted in FIG. 10A. A cap 1002 containing beads B decorated with one or more substances displaying a particular affinity with a target within the sample S may be first selected, as required or desired for a particular process. In FIG. 10B, the Introducing Sample operation is performed by inverting the container 1000 and cap 1002, such that the liquid L sample flows into the chamber of the cap 1002, through the filter wall 1006. The Mixing Beads/Sample operation may be performed by agitating or vortexing the container 1000 and cap 1002, such that the liquid L sample mixes with the beads B retained behind a filter wall 1006, as described herein. Thereafter, the container 1000 and the cap 1002 may be uprighted, causing the liquid L sample to fall back into the container 1000. In doing so, the Separating Beads operation is performed by the beads B being retained in the cap 1002. The liquid L remaining in the container 1000 may be removed e.g., via a pipette, once the cap 1002 is removed. Thereafter, the Initiating Further Process operation may performed, as known in the art.

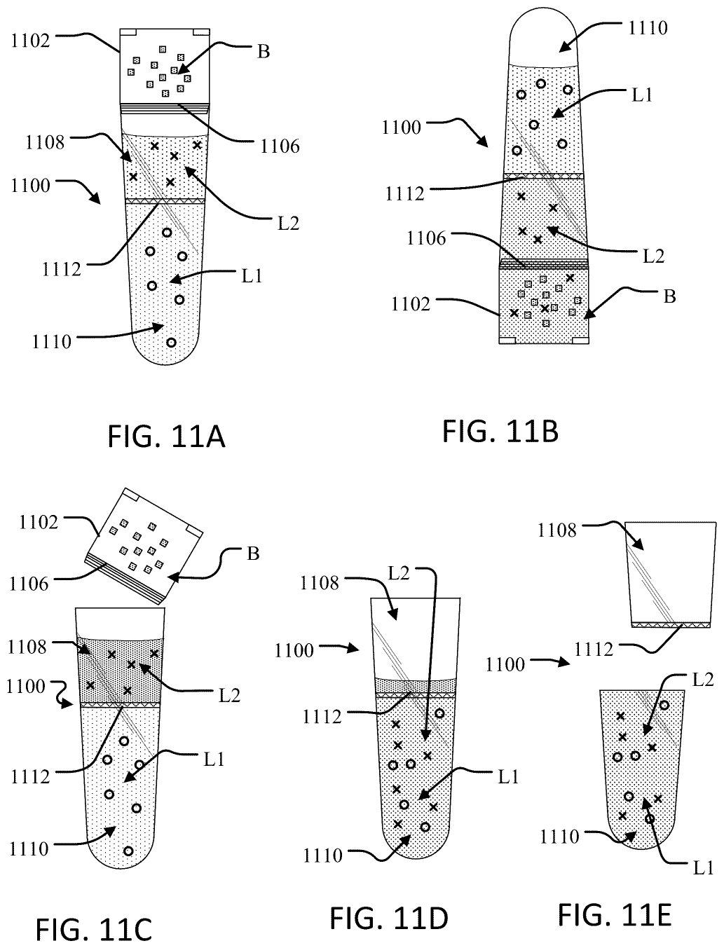

FIGS. 11A-11E depict another example method of processing a sample in a container 1100, in accordance with the method of FIG. 6. A cap 1102 containing a plurality of beads B is also depicted and the container 1100 which may be consistent with the container 400 such as depicted in FIG. 4. The container 1100 includes an upper chamber 1108 containing a liquid L2, which may be a sample. The container 1100 also includes a lower chamber 1110 containing a liquid L1, which may be a reagent. The upper chamber 1108 and lower chamber 1110 may separated by a rupturable wall 1112. The cap 1102 may be consistent with the cap 300 depicted in FIG. 3. This implementation of the method 600 begins with the Applying Cap operation, where the cap 1102 containing the beads B is secured to the container 1100, as depicted in FIG. 11A. A cap 1102 containing beads B decorated with one or more substances displaying a particular affinity with a target within a sample S may be first selected, as required or desired for a particular process. In FIG. 11B, the Introducing Sample operation is performed by inverting the container 1100 and cap 1102, such that the liquid L2 sample flows into the chamber of the cap 1102, through the filter wall 1106. The Mixing Beads/Sample operation may be performed by agitating or vortexing the container 1100 and cap 1102, such that the liquid L2 sample mixes with the beads B retained behind a filter wall 1106, as described herein. Thereafter, the container 1100 and the cap 1102 may be uprighted, causing the liquid L2 sample to fall back into the upper chamber 1108 of the container 1100. In doing so, the Separating Beads operation is performed by the beads B being retained in the cap 1102. Thereafter, the cap 1102 may be removed and the rupturable wall 1112 may be penetrated, allowing the liquid L2 sample to fall into the lower chamber to mix with the liquid L1 therein. The upper compartment 1108 may then be separated from the lower compartment 1110 and the liquid L1, L2 remaining in the container 1100 may be removed, e.g., via a pipette. Thereafter, the Initiating Further Process operation may performed, as known in the art.

This disclosure described some examples of the present technology with reference to the accompanying drawings, in which only some of the possible examples were shown. Other aspects can, however, be embodied in many different forms and should not be construed as limited to the examples set forth herein. Rather, these examples were provided so that this disclosure was thorough and complete and fully conveyed the scope of the possible examples to those skilled in the art.

Although specific examples were described herein, the scope of the technology is not limited to those specific examples. One skilled in the art will recognize other examples or improvements that are within the scope of the present technology. Therefore, the specific structure, acts, or media are disclosed only as illustrative examples. Examples according to the technology may also combine elements or components of those that are disclosed in general but not expressly exemplified in combination, unless otherwise stated herein. The scope of the technology is defined by the following claims and any equivalents therein.

What is claimed is:

1. A method for processing a sample in a container, the method comprising:
introducing the sample to the container;
applying a cap to the container, wherein the cap contains a plurality of beads;
mixing the plurality of beads with the sample;
separating the plurality of beads from the sample; and
subsequent to removing the plurality of beads, initiating a further process.

2. The method of claim 1, further comprising introducing a reagent to the container prior to introducing the sample to the container.

3. The method of claim 1, further comprising introducing the sample to the cap, prior to mixing the plurality of beads with the sample.

4. The method of claim 1, wherein separating the plurality of beads from the sample comprises rupturing the cap, thereby initiating the introduction of the sample to the container, and wherein the cap retains the plurality of beads within the cap during rupturing of the cap.

5. The method of claim 1, wherein:
mixing the plurality of beads with the sample comprises inverting the container so as to contact the plurality of beads in the cap with the sample;
separating the plurality of beads from the sample comprises uprighting the container; and
wherein the method further comprises introducing a reagent to the container, prior to initiating a further process of the sample.

6. The method of claim 1, wherein the plurality of beads are non-magnetic.

7. The method of claim 3, further comprising:
subsequent to introducing the sample to the cap, rupturing the cap, thereby initiating the introduction of the sample to the container and introducing the plurality of beads to the container, and
wherein separating the plurality of beads from the sample comprises, subsequent to introducing the plurality of beads to the container, applying a magnetic force to the plurality of beads and separating the beads from the sample.

8. The method of claim 7, wherein applying the magnetic force to the plurality of beads draws the plurality of beads into the cap, and wherein the method further comprises removing the cap from the container along with the plurality of beads.

9. The method of claim 3, further comprising:
subsequent to introducing the sample to the cap, applying a magnetic force to the plurality of beads so as to retain the plurality of beads in the cap; and
rupturing the cap, thereby initiating the introduction of the sample to the container.

10. The method of claim 9, wherein applying the magnetic force and rupturing the cap are performed substantially simultaneously.

11. The method of claim 1, further comprising rupturing the cap, thereby initiating the mixing of the plurality of beads with the sample, and wherein removing the plurality of beads from the sample comprises applying the magnetic force to the plurality of beads to draw the plurality of beads into the cap.

12. The method of claim 1, wherein introducing the sample to the container comprises introducing the sample to an upper compartment of the container.

13. The method of claim 12, further comprising, subsequent to introducing the plurality of beads to the sample, rupturing a barrier between the upper compartment of the container and a lower compartment.

14. The method of claim 13, further comprising, prior to rupturing the barrier, applying a magnetic force to the plurality of beads so as to at least one of retain the plurality of beads in the upper compartment of the container and draw the plurality of beads into the cap.

15. A cap for a sample container, the cap comprising:
a housing defining an inner chamber;
a base connected to the housing;
a sealing rim connected to the housing and substantially surrounding the base for sealing engagement with the sample container; and
a plurality of beads disposed in the inner chamber.

16. The cap of claim 15, further comprising a rupturable lid.

17. The cap of claim 15, wherein the base is rupturable.

18. The cap of claim 15, further comprising a filter wall disposed in the inner chamber, wherein the filter wall separates the inner chamber into a sample chamber and a bead chamber, wherein the plurality of beads are contained in the bead chamber, and wherein the rupturable base at least partially defines the sample chamber.

19. The cap of claim 15, wherein the base comprises a filter.

20. The container for processing a sample, the container comprising:
an upper chamber;
a lower chamber;
a rupturable wall separating the upper chamber and the lower chamber; and
a cap sealingly connected to the upper chamber, wherein the cap comprises an inner chamber and a plurality of beads disposed in the inner chamber.
